(19) United States
(12) Patent Application Publication
(10) Pub. No.: US 2022/0095071 A1
(43) Pub. Date: Mar. 24, 2022

(54) APPLYING DIRECTIONALITY TO AUDIO BY ENCODING INPUT DATA

(71) Applicant: Hewlett-Packard Development Company, L.P., Spring, TX (US)

(72) Inventor: Sunil Ganpatrao Bharitkar, Palo Alto, CA (US)

(73) Assignee: Hewlett-Packard Development Company, L.P., Spring, TX (US)

(21) Appl. No.: 17/419,313

(22) PCT Filed: Apr. 9, 2019
(86) PCT No.: PCT/US2019/026495

§ 371 Date: Jun. 29, 2021

(51) Int. Cl. H04S 7/00; G10L 19/008; G06N 3/08

(52) U.S. Cl. CPC H04S 7/302; G10L 19/008; H04S 2400/11; H04S 2420/01; G06N 3/08

(57) ABSTRACT

The present disclosure describes techniques for adding a perception of directionality to audio. The method includes training an artificial neural network using a binary encoded set of head related transfer function (HRTF) angle values to generate a trained artificial neural network. The binary encoded set of HRTF angle values includes binary encoded azimuth angle values and binary encoded elevation angle values. The method also includes predicting output data using the trained artificial neural network. The output data represents a new head related transfer function reconstructed for a specified direction.

### BACKGROUND

Humans use their ears to detect the direction of sounds. Among other factors, humans use the delay between the two sounds and the shadowing of the head against sounds originating from the other side to determine the direction of sounds. The ability to rapidly and intuitively localize the origination of sounds helps people with a variety every day activities, as we can monitor our surroundings for hazards (like traffic) even when we can't see the direction they are coming from.

### BRIEF DESCRIPTION OF THE DRAWINGS

The following detailed description references the drawings, in which:

FIG. 1 is a block diagram of an example system for adding directionality to audio;

FIG. 2 illustrates a machine learning model for transforming input data to a binary form;

FIG. 3 is a process flow diagram showing an example process for generating HRTF reconstruction models;

FIGS. 4A, 4B and 4C depict comparisons between various approaches for different types of encoding according to examples described herein;

FIG. 5 is a process flow diagram summarizing a method of adding directionality to audio using the HRTF reconstruction models; and

FIG. 6 is a high-level block diagram showing a medium that contains logic for rendering audio to generate a perception of directionality.

### DETAILED DESCRIPTION

Data transforms, parameter re-normalization, and activation functions may be used in machine learning systems to speed convergence and increase robustness. For example, such techniques may be utilized in various computer vision applications. In some examples, it may be desirable to know how various data normalization approaches and activation functions can be applied to the audio signal domain and what performance gains can be expected for specific audio-pertinent problems.

Various techniques are described below that employ a novel approach, in the context of function approximation, for mapping input data to an output lower dimensional representation during synthesis of head related transfer functions (HRTFs). A head related transfer function translates a noise originating at a given lateral angle and elevation (positive or negative) into two signals captured at either ear of the listener. In practice, HRTFs exist as a pair of impulse (or frequency) responses corresponding to a lateral angle, an elevation angle, and a frequency of the sound. In some examples, HRTFs can be used to perform a multi-channel audio to binaural audio conversion. According to an example, input data representing audio signals can be encoded using n-bit encoding techniques. According to an example, utilization of the disclosed encoding approach outperforms other forms of normalization in terms of convergence speed and robustness to neural network parameter initialization.

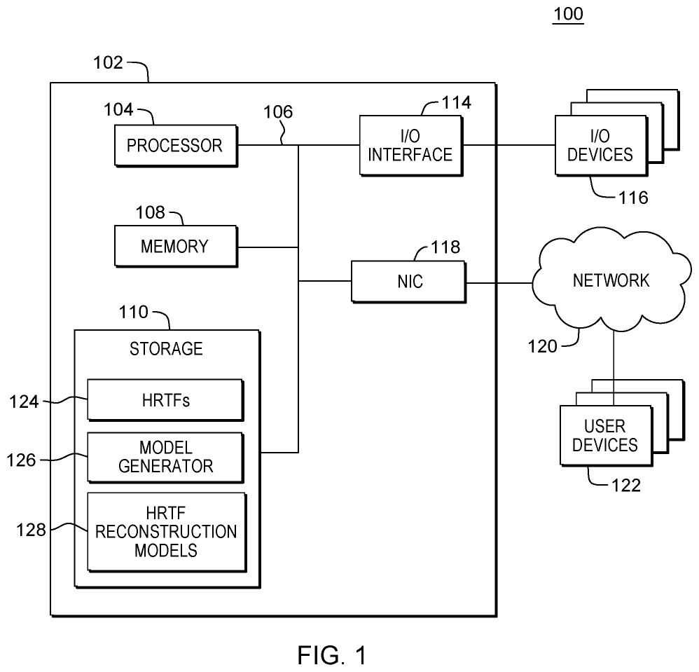

FIG. 1 is a block diagram of an example system for adding directionality to audio. The system 100 includes a computing device 102. The computing device 102 can be any suitable computing device, including a desktop computer, laptop computer, a server, and the like. The computing device 102 includes at least one processor 104. The processor 104 can be a single core processor, a multicore processor, a processor cluster, and the like. The processor 104 can be coupled to other units through a bus 106. The bus 106 can include peripheral component interconnect (PCI) or peripheral component interconnect express (PCIe) interconnects, Peripheral Component Interconnect eXtended (PCIx), or any number of other suitable technologies for transmitting information.

The computing device 102 can be linked through the bus 106 to a system memory 108. The system memory 108 can include random access memory (RAM), including volatile memory such as static random-access memory (SRAM) and dynamic random-access memory (DRAM). The system memory 108 can also include directly addressable non-volatile memory, such as resistive random-access memory (RRAM), phase-change memory (PCRAM), Memristor, Magnetoresistive random-access memory, (MRAM), Spin-transfer torque Random Access Memory (STTRAM), and any other suitable memory that can be used to provide computers with persistent memory. In an example, a memory can be used to implement persistent memory if it can be directly addressed by the processor at a byte or word granularity and has non-volatile properties.

The computing device 102 can include a tangible, non-transitory, computer-readable storage media, such as a storage device 110 for the long-term storage of data, including the operating system programs, software applications, and user data. The storage device 110 can include hard disks, solid state memory, or other non-volatile storage elements.

The processor 104 may be coupled through the bus 106 to an input output (I/O) interface 114. The I/O interface 114 may be coupled to any suitable type of I/O devices 116, including input devices, such as a mouse, touch screen, keyboard, display, and the like. The I/O devices 116 may also be output devices such as a display monitor.

The computing device 102 can also include a network interface controller (NIC) 118, for connecting the computing device 102 to a network 120. In some examples, the network 120 can be an enterprise server network, a storage area network (SAN), a local area network (LAN), a wide-area network (WAN), or the Internet, for example. In some examples, the network 120 is coupled to one or more user device 122, enabling the computing device 102 to store data to the user devices 122.

The storage device 110 stores data and software used to generate models for adding directionality to an audio signal, including the HRTFs 124, and the model generator 126. The HRTFs may be the measured HRTFs described above, such as the IRCAM (Institute for Research and Coordination in Acoustics and Music) Listen HRTF dataset, the MIT (Massachusetts Institute of Technology) KEMAR (Knowles Electronics Manikin for Acoustic Research) dataset, the UC Davis CIPIC (Center for Image Processing and Integrated Computing) dataset, and others. The HRTFs may also be proprietary datasets. In some examples, the HRTFs may be sampled at increments of 15 degrees. However, it will be appreciated that other sampling increments are also possible, including 5 degrees, 10 degrees, 20 degrees, 30 degrees and others. Additionally, the HRTFs can include one set representing the left ear and a second set representing the right ear.

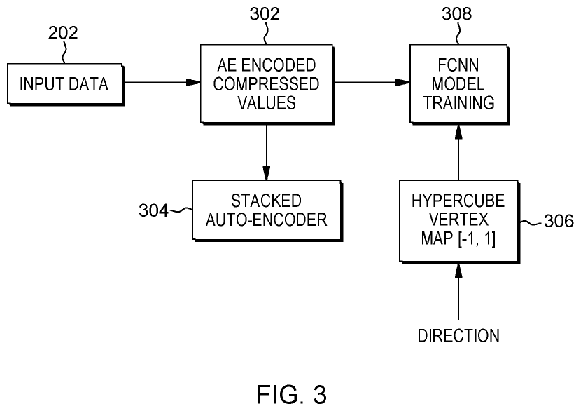

The model generator 126, using the HRTFs 124 as input, generates a model that can be used to add directionality to sound. For example, as described further below in relation to FIG. 3, the model generator 126 may create an autoencoder that generates a compressed representation of the input HRTFs. The autoencoder can be separated into an encoder portion and a decoder portion. The deepest layer of the encoder portion may be used to train an artificial neural network that enables reconstruction of new HRTFs at arbitrary angles. The model generator 126 may generate a first autoencoder and first artificial neural network for the left ear and a second autoencoder and second artificial neural network for the right ear.

The artificial neural networks and the decoder portions of the autoencoders are referred to in FIG. 1 as HRTF reconstruction models 128. The HRTF reconstruction models 128 may be stored and copied to any number of user devices 122, such as gaming systems, virtual reality headsets, media players, and any other type of device capable of rendering audio to the two ears separately. The HRTF reconstruction models 128 can be used to add directionality to an audio signal rendered by the user device 122.

It is to be understood that the block diagram of FIG. 1 is not intended to indicate that the computing device 102 is to include all of the components shown in FIG. 1. Rather, the computing device 102 can include fewer or additional components not illustrated in FIG. 1. For example, the computing device 102 can include additional processors, memory controller devices, network interfaces, software applications, etc.

In some examples measured HRTF data sets may be sparse, meaning they may have data at intervals larger than the resolution of the average person. For example, the IRCAM Listen HRTF dataset is spatially sampled at 15-degree intervals. To provide a more realistic sound environment, the present disclosure describes techniques for generating interpolated HRTFs. The generation of the interpolated HRTFs may be accomplished through the use of trained artificial neural networks. For example, a stacked autoencoder and artificial neural network are trained using the HRTFs as an input. The result is an artificial neural network and decoder that can reconstruct HRTFs for arbitrary angles, for example, every 1 degree. In another example, a Principal Component Analysis (PCA) model may be used instead of the autoencoder to train an artificial neural network.

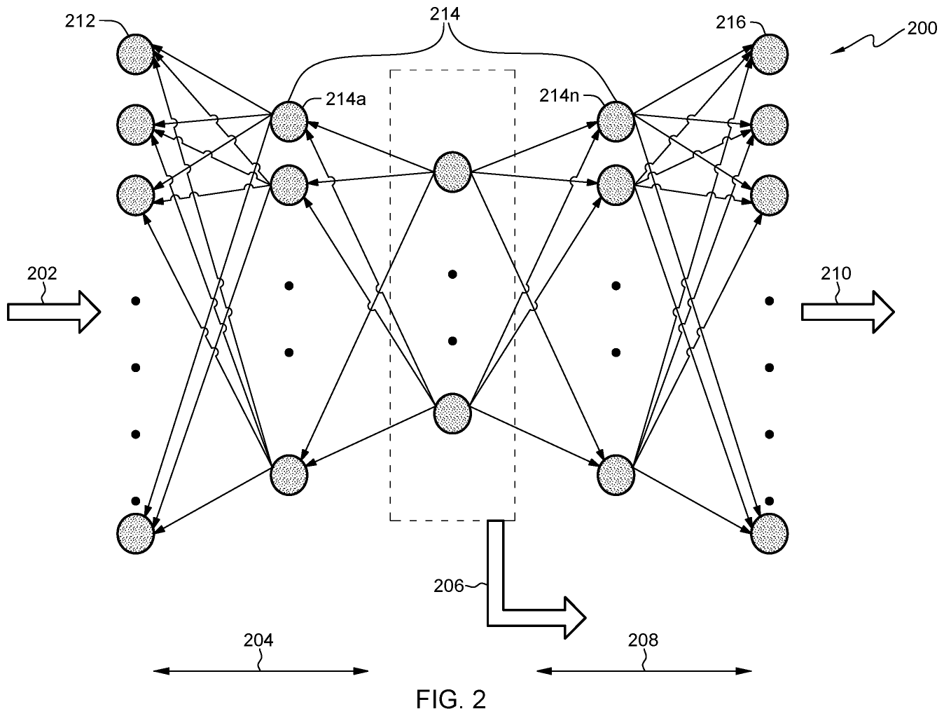

FIG. 2 illustrates a machine learning model for transforming input data to a binary form. In one example the machine learning model may include at least one neural network. Generally, a neural network is a collection of elements that accept incoming input values, perform operations on those values, and compute single valued output values. These three functions correspond to three different parts of a general element of a neural network—input, activation, and output.

A representative example of the neural network 200 is shown. It should be noted that the autoencoder example shown in FIG. 2 is merely illustrative of an exemplary neural network 200 and other examples for neural network 200 can be used.

The neural network 200 has an input layer 212, a plurality of hidden layers 214, and an output layer 216. The input layer 212 includes a set of input elements which receive input values from the external input data 202. The input layer 212 is just a collection of storage locations for the received input values 202 and does not contain any processing elements; instead, it is a set of storage locations for input values 202.

The next layer, a first hidden layer 214a also includes a set of elements. The outputs from input layer 212 are used as inputs by each element of the first hidden layer 214a. Thus, it can be appreciated that the outputs of the previous layer are used to feed the inputs of the next layer. As shown in FIG. 2, additional hidden layers would take the outputs from the previous layer as their inputs as well. Any number of hidden layers 214 can be utilized in the neural network 200.

Output layer 216 also has a set of elements that take the output of elements of the last hidden layer 214n as their input values. The outputs 210 of elements of the output layer 216 are the predicted values (called output data) produced by the neural network 200 using the input data 202.

It should be noted that for ease of illustration purposes only, no weights are shown in FIG. 2. However, each connection between the layers 214 has an adjustable constant called a weight. Weights determine how much relative effect an input value has on the output value of the element in question.

When each hidden layer element connects to all of the outputs from the previous layer, and each output element connects to all of the outputs from the previous layer, the network is called fully connected. Note that if all elements use output values from elements of a previous layer, the network is a feedforward network. The neural network 200 of FIG. 2 is such a fully connected, feedforward network. Note that if any element uses output values from an element in a later layer, the network is said to have feedback.

As noted above, the neural network 200 of FIG. 2 is an autoencoder (AE) neural network. The AE is a feed-forward neural network with one or more hidden layers. The goal of an AE is to minimize the difference between the input and output vectors. If the hidden layer has a size equal to or larger than the input layer 212, an AE may learn and identify transformation. To prevent such a trivial solution, an AE can be set up with a hidden layer with fewer nodes than the input layer 212. The nodes of the hidden layer can be calculated as a function of a bias term and a weighted sum of the nodes of the input layer 212, where a respective weight is assigned to each connection between a node of the input layer 212 and a node in the hidden layer. The bias term and the weights between the input layer 212 and the hidden layer are learned in the training of the AE neural network, for example using a back-propagation algorithm.

As noted above, input data representing audio signals can be encoded using n-bit encoding techniques. In one example, one or more hidden layers following the input layer 212 may be used as an encoder structure 204. One hidden layer can represent any function, In one example, the encoder structure 204 of the autoencoder 200 may be used to transform input data (HRTF data) into binary representation using binary encoding described in greater detail below. Accordingly, one or more hidden layers preceding the output layer 316 may be used as a decoder structure 208, as shown in FIG. 2. The decoder structure 208 is used to reconstruct HRTF values in the magnitude domain.

FIG. 3 is a process flow diagram showing an example process for generating HRTF reconstruction models. In one example, the process starts with receiving an HRTF data set as input data 202. Measured HRTFs may include binaural cues for localizing a sound-source in a 3D-space. The HRTF data may also account for the sound diffraction caused by the listeners head, torso and, given manner in which measurement data are taken, outer ear effects as well. For example, the left and right HRTF for a particular azimuth and elevation angle of incidence can evidence a 20 dB difference due to interaural effects as well a 600 micro second delay (where the speed of sound, c, is approximately 340 meters/second). Separate HRTF data sets will be used for the right ear process and the left ear process.

This HRTF data is used to train an unsupervised autoencoder. The goal of the training is to minimize the difference between the input and the output.

As noted above, HRTF data includes azimuth and elevation angles. The constraints for the horizontal and elevation angles are θ∈[0;360], ϕ∈[0;180], respectively. According to some examples, the input data 202 is encoded using n-bit encoding. In one example, the n-bit encoding is a binary encoding. In other words, the input data 202 having angle values in the range of 0-360 is being mapped to the linear segment of an activation function of a neural network through binary encoding of the corresponding angle values. It should be noted that some activation functions may have one or more linear segments with trainable variables. This representation is effectively mapping the input data to the vertices of a unit hypercube where each input angle pair is represented by a binary vector. The hypercube can also be viewed as a graph, where the vertices or nodes are the n-tuples and the edges are the binary subsets {u, v} such that the distance |u+v| (Hamming distance) is equal to 1. Two vectors u and v of an edge are called adjacent points of the hypercube. In other words, azimuth angles θ∈[0;180] are transformed by the encoder structure 204 to base N (e.g., base 2 or binary values) to generate a first input vector—(P-dim vector)->aₚ, while elevation angles ϕ∈[0;90] are also transformed to base N (e.g., base 2) to generate a second input vector (Q-dim vector)->b_{q}. These vector pairs (P-dim vector and Q-dim vector) representing angle values are mapped to the vertices of a unit hypercube. This transformation may be followed by a quantization into uniform vectors:

aₚ->aₚ-(N−1)/2 and b_{q}->b_{q}-(N−1)/2.

According to an example, in order to make mapping of angle values even more efficient, the encoder structure 204 may utilize a sign bit. A sign bit may be encoded based on the plurality of angle values. The sign bit indicates locations of corresponding audio signals in space relative to a median plane (θ, ϕ)=(0, 0). In one example, a positive sign bit may be assigned to all angle values located in the left half of a median plane and a negative sign bit may be assigned to all angle values located in the right half of the median plane. In other words, the encoded input data vectors containing the binary representations for both the horizontal and vertical angles may be represented as following vectors: θ_{b}=Bₙ (θ) and ϕ_{b}=Bₘ (ϕ), where n=8 and m=7 is the order of the binary representation. An additional sign bit bₙ₊₁∈{−1,0} is used to indicate whether an angle value is located in the left half or right half with respect to a median plane.

Advantageously, this compression of the input data 202 into the compressed angle values enables the inner product to be computed during convolution using particular operations that are typically faster, as compared to original (un-transformed) input data 202.

The greedy layer wise approach may be used for pretraining a neural network by training each layer in turn. In other words, two or more autoencoders can be “stacked” in a greedy layer wise fashion for pretraining (initializing) the weights of a neural network. As shown in FIG. 3, the AE encoded compressed values 302 may be forwarded to a stacked autoencoder 304 to initialize the weights for pretraining purposes. The initialized weights from the stacked autoencoder 304 can be used for training purposes by feeding weights to the artificial neural network being trained 308. As shown at block 306, the input data may be effectively mapped to the vertices of a unit hypercube where each input angle pair is represented by a binary vector. Accordingly, the hypercube vertex map 306 may also be used for training purposes by the artificial neural network being trained 308.

In one example, the artificial neural network 308 may be a convolutional neural network (CNN). In other examples, the artificial neural network 300 may be a fully connected neural network or a multilayer perceptron. The multilayer perceptron may include at least three layers of nodes: an input layer, a hidden layer and an output layer. Except for the input nodes, each node is a neuron that uses a nonlinear activation function.

In one example, for the case of the deep-learning AE, jitter values may be added to the input angle values 202 (when angle values are real numbers) which can be viewed as measurement error in the angles during the measurement process. This can be done, for example, by introducing gaussian distributed noise with mean given by the angle in the dataset and variance. This step generally prevents the setup to be ill-conditioned. The trained artificial neural network, shown at block 308, is stored for later use in the process for reconstructing new HRTFs at arbitrary angles and forms the next part of the HRTF reconstruction model 128 shown in FIG. 1.

As a non-limiting example of the binary encoding transformation, the binary encoding function may be computed according to the following equation:

Encoding=truncate(rem(a*2^{z}/2))

In the above equation, truncate ( ) returns the integer part of a number, rem( ) is the remainder after division function, a is the real number value of the input angle and z is a vector of integer values from −(n−1) to m. The real number value of the input angle value includes integer part and fractional part. In one example, n may be the number of bits used to represent the integer part of a and m may be the number of bits to represent the fractional part of a. In one example, if n=16 and m=25 (i.e., z is (−15, −14, −13, −12, −11, −10, . . . , 23, 24, 25)) and if the value of a is 37.94, the input angle value of a may be represented as following in the binary form:

Bits 1 through 16

| | | | | | | | | | | | | | | | |
|---|---|---|---|---|---|---|---|---|---|---|---|---|---|---|---|
| 0 | 0 | 0 | 0 | 0 | 0 | 0 | 0 | 0 | 0 | 1 | 0 | 0 | 1 | 0 | 1 |

Bits 17 through 32

| | | | | | | | | | | | | | | | |
|---|---|---|---|---|---|---|---|---|---|---|---|---|---|---|---|
| 1 | 1 | 1 | 1 | 0 | 0 | 0 | 0 | 1 | 0 | 1 | 0 | 0 | 0 | 1 | 1 |

Bits 33 through 41

| | | | | | | | | |
|---|---|---|---|---|---|---|---|---|
| 1 | 1 | 0 | 1 | 0 | 1 | 1 | 1 | 0 |

In one example, the smallest values of (n;m) of the size of the binary vector may be determined to represent the input angles having real number values. The jittered values ensure that any angle values yield unique binary encoded vectors. In one example, the smallest values for n and m may be determined by iteratively adjusting n and m for the encoding of the jittered angle values, building a Hamming distance matrix from the binary representations, and ensuring the distances between the binary vectors are greater than zero. In one example, the smallest n=16 (including sign bit) and m=14 that yields 5635 unique jittered angle values.

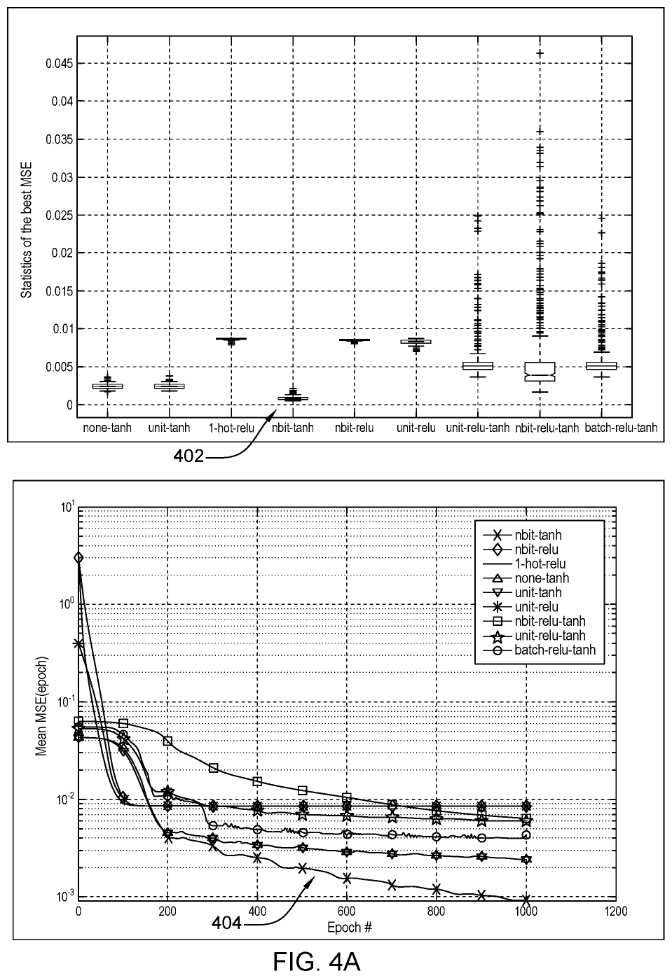

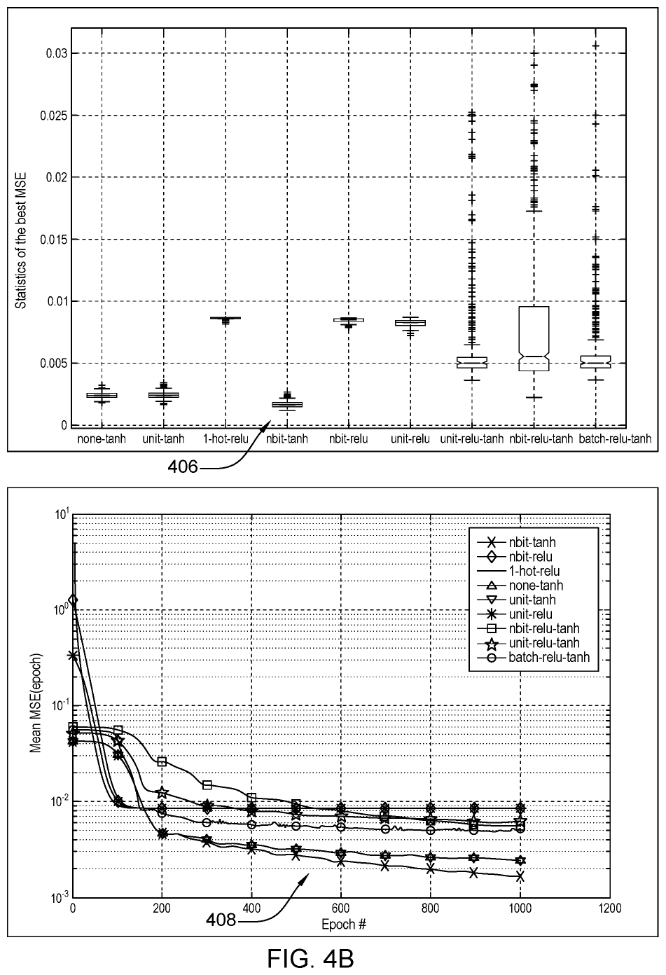

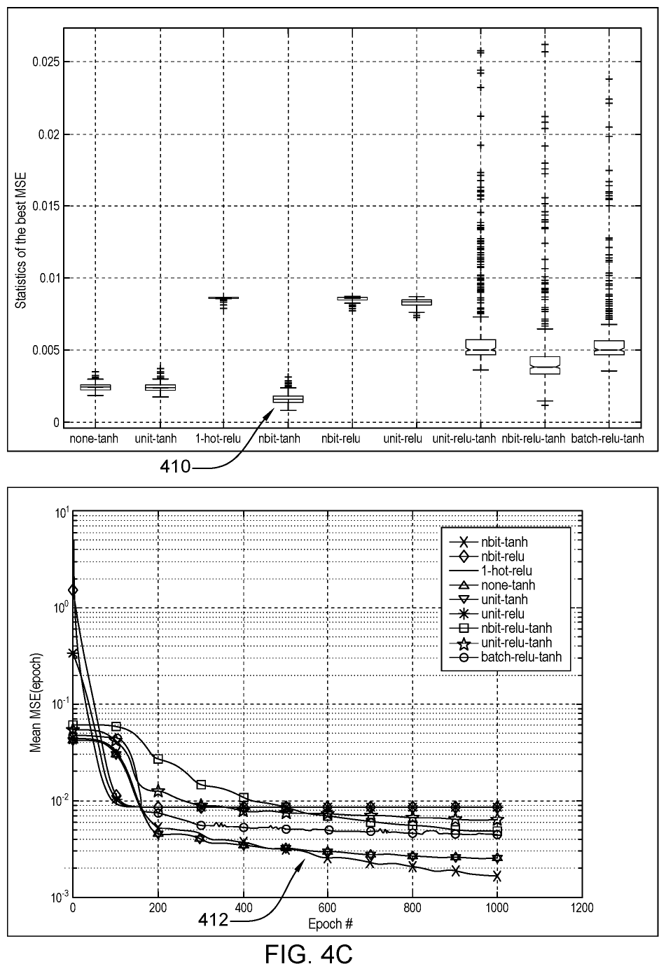

FIGS. 4A, 4B and 4C depict comparisons between various approaches for different types of encoding according to examples described herein. More specifically, the following encoding approaches are compared: no normalization (input angles are used in degrees), unit normalization, one-hot encoding and n-bit encoding. A one-hot neural network uses encoded 4-bit weights that enable machine learning calculations to be simplified in part into a set of right-shift and accumulation operations that may be performed in a highly efficient manner using general-purpose graphics processing logic. Comparison between various approaches may also be used to determine which of the candidate activation functions acts as the best predictor for a particular layer. The candidate activation functions contain parameters (weights) that are optimized using the reduced data set. Once the parameters for the candidate activation functions and the encoding approach are determined, each candidate activation function is tested by a single pass through the data. The predicted outcomes of each combination of encoding and candidate activation function can be ranked according to the ability of a candidate activation function to match the target variable. For example, the trained model may use a sum of square errors function or an accuracy rate to rank combinations of candidate data normalization techniques and the candidate activation functions. It should be noted that in FIGS. 4A-4C only tanh (hyperbolic tangent activation function) and ReLU (Rectified Linear Unit) candidate activation functions are compared. The hyperbolic tangent activation function is represented by the following formula (1):

a*tanh(b*x) (1),

where a and b are two parameters. The ReLU function is half rectified (from bottom). F(z) is zero when z is less than zero and f(z) is equal to z when z is above or equal to zero.

Referring to FIGS. 4A-4C, the graphs illustrated therein represent the following combinations: no normalization with the tanh activation function, unit normalization with the tanh activation function, one-hot encoding with the ReLU activation function, n-bit encoding with the tanh activation function, unit encoding with the ReLU activation function, unit encoding with both ReLU and tanh activation functions, n-bit encoding with both ReLU and tanh activation functions and batch normalization with ReLU and tanh activation functions. Furthermore, n-bit encoding is represented by a base-2 (binary encoding) in FIG. 4A, base-3 encoding in FIG. 4B and base-4 encoding in FIG. 4C. The mean square error (MSE) is a typical error measure used in comparing the prompt input with the neural network output. Other error measures also possible. To calculate MSE, first an error vector is formed as the difference between the prompt input and the neural network output pattern vectors. MSE is then calculated by summing the squares of the components of the error vector and dividing by the number of components in the vector. FIGS. 4A-4C demonstrate, in a statistically significant way, that binary encoding with the tanh activation function 402 (represented by graph 404) outperforms not only base −3 encoding with the tanh activation function 406 (represented by graph 408) and base-4 encoding with the tanh activation function 410 (represented by graph 412) but also outperforms all other forms of normalization in terms of convergence speed and robustness to network parameter initialization.

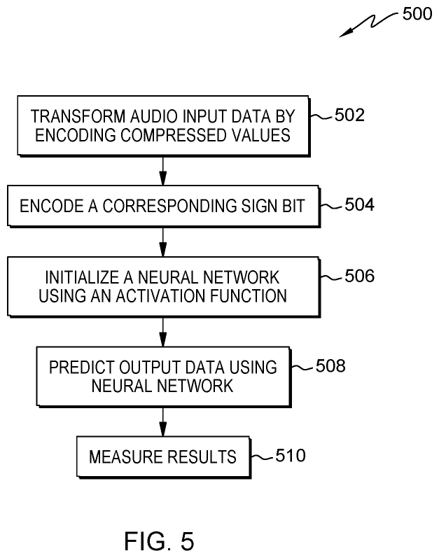

FIG. 5 depicts a flow diagram of a method 500 transforming audio input data to improve performance of a neural network according to examples described herein. The method 500 is executable by a computing device such as the computing device 102 of FIG. 1.

At block 502 of FIG. 5, the encoder structure 304 of the autoencoder neural network 200 receives audio input data 202 from the input layer 212 and transforms the input data 202 by encoding compressed input data values. In some examples, the encoding can be binary encoding. The input data 202 may include HRTF angle values. In one example, the HRTF angle values may include an azimuth angle of incidence and an elevation angle of incidence.

At block 504, the encoder structure 204 of the autoencoder neural network 200 encodes a corresponding sign bit. In one example, a positive sign bit may be assigned to all angle values located in the left half of a median plane and a negative sign bit may be assigned to all angle values located in the right half of the median plane. In this example, the encoder structure 204 may utilize 8 bits to represent binary angle values, while 9th bit may be used as a sign bit. Advantageously, this compression of the input data 202 into the compressed angle values enables the inner product to be computed during convolution using particular operations that are typically faster, as compared to original (un-transformed) input data 202.

At block 506, the artificial neural network 308 is initialized using an activation function. As part of the initialization process, a set of network weights for interconnections between neural network layers is generated. In various examples, the tanh activation function or the ReLU activation function could be used by the artificial neural network 308. Upon completion of the initialization process, training of the artificial neural network 308 may start. The initialized weights from the stacked autoencoder 404 can be used for training purposes by feeding weights to the artificial neural network being trained 308. The training process of neural networks involves adjusting the weights till a desired input/output relationship is obtained. In some examples, gradient descent algorithm may be used for training purposes. In various examples either first-order or second-order gradients may be employed for training purposes.

At block 508, the artificial neural network 308 enters the operation (prediction) mode. In the operation mode, the artificial neural network 308 is supplied with the encoded input data (e.g., binary encoded input data), and produces output data based on predictions. Prediction is done using any presently known or future developed approach. For example, if a nonlinear deep learning technique employing a sparse AE is used, the output values may include the latent representation of the AE, corresponding to the input angles. The output of the trained artificial neural network 308 is a set of decoder input values, corresponding to the input direction. The set of decoder input values generated by the trained artificial neural network 308 are input to the decoder portion 208 of the trained autoencoder. The output of the decoder portion 208 of the trained autoencoder is a reconstructed HRTF representing an estimate of an interpolated frequency-domain HRTF that is suitable for processing the audio signal to create the impression that the sound is emanating from the input direction information. For example, if the original HRTFs were sampled at angles of 15 degrees, interpolated HRTFs may be generated for subspace angle increments, such as, 1-degree increments. At block 510, performance of the artificial neural network 308 is measured. In other words, the measured output values are compared to the predicted output values to measure the performance, or predicting accuracy, of the network. In one example, the MSE may be used to measure the performance of the artificial neural network.

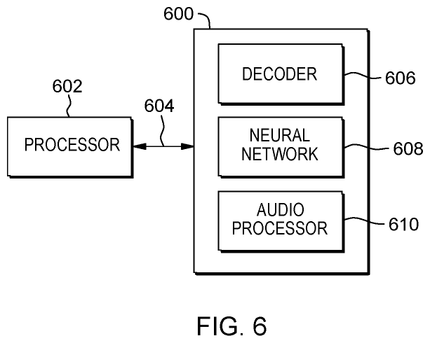

FIG. 6 is a block diagram showing a medium 600 that contains logic for rendering audio to generate a perception of directionality. The medium 600 may be a non-transitory computer-readable medium that stores code that can be accessed by a processor 602 over a computer bus 604. For example, the computer-readable medium 600 can be volatile or non-volatile data storage device. The medium 600 can also be a logic unit, such as an Application Specific Integrated Circuit (ASIC), a Field Programmable Gate Array (FPGA), or an arrangement of logic gates implemented in one or more integrated circuits, for example.

The medium 600 includes an autoencoder trained decoder 606 to compute a transfer function based on a compressed representation of the transfer function. The medium also includes a trained neural network 608 to cause the processor to select the compressed representation of the transfer function based on an input direction representing a directionality of sound included in the audio signal. The medium also includes logic instructions 610 that direct the processor 602 to process an audio signal based on the transfer function and send the modified audio signal to a first speaker.

The block diagram of FIG. 6 is not intended to indicate that the medium 600 is to include all of the components shown in FIG. 6. Further, the medium 600 may include any number of additional components not shown in FIG. 6, depending on the details of the specific implementation.

While the present techniques may be susceptible to various modifications and alternative forms, the techniques discussed above have been shown by way of example. It is to be understood that the technique is not intended to be limited to the particular examples disclosed herein. Indeed, the present techniques include all alternatives, modifications, and equivalents falling within the scope of the following claims.

What is claimed is:

1. A method for adding a perception of directionality to audio, the method comprising:
training an artificial neural network using a binary encoded set of head related transfer function (HRTF) angle values to generate a trained artificial neural network, wherein the binary encoded set of HRTF angle values includes binary encoded azimuth angle values and binary encoded elevation angle values; and
predicting output data using the trained artificial neural network, wherein the output data represents a new head related transfer function reconstructed for a specified direction.

2. The method of claim 1, comprising training an autoencoder based on the HRTF angle values, wherein a deepest layer of an encoder portion of the autoencoder is a compressed representation of the HRTF angle values and is used to train the artificial neural network.

3. The method of claim 1, wherein the artificial neural network comprises at least one of a convolutional neural network (CNN) or a multilayer perceptron.

4. The method of claim 1, wherein the binary encoded set of HRTF angle values further includes a sign bit indicative of locations of the corresponding binary encoded azimuth angle values and the binary encoded elevation angle values with respect to a median plane.

5. The method of claim 2, wherein the autoencoder is further trained based on generated unique jittered values for corresponding azimuth angle values and elevation angle values.

6. The method of claim 1, wherein the trained artificial neural network comprises two hidden layers and wherein at least one of the two hidden layers comprises a hyperbolic tangent activation function.

7. The method of claim 1, wherein the binary encoded set of HRTF angle values is generated by mapping pairs of HRTF angle values to vertices of a unit hypercube, wherein each HRTF angle value pair is represented by a binary vector.

8. A system for rendering audio, comprising:
a processor; and
a memory comprising instructions to direct the actions of the processor, wherein the memory comprises:
a neural network to cause the processor to compute a representation of a binary encoded set of head related transfer function (HRTF) angle values, wherein the binary encoded set of HRTF angle values includes binary encoded azimuth angle values and binary encoded elevation angle values; and
a HRTF reconstruction model to cause the processor to compute a new head related transfer function reconstructed for a specified direction based on the representation of the binary encoded set of head related transfer function (HRTF) angle values.

9. The system of claim 8, wherein the neural network comprises a fully connected feedforward network.

10. The system of claim 9, wherein the binary encoded set of HRTF angle values is mapped to a linear part of an activation function of the neural network.

11. The system of claim 8, wherein the binary encoded set of HRTF angle values further includes a sign bit indicative of locations of the corresponding binary encoded azimuth angle values and the binary encoded elevation angle values with respect to a median plane.

12. The system of claim 9, wherein the fully connected neural network comprises two hidden layers and wherein at least one of the two hidden layers comprises a hyperbolic tangent activation function.

13. A tangible, non-transitory, computer-readable medium comprising instructions that, when executed by a processor, direct the processor to:
receive a set of binary encoded head related transfer function (HRTF) angle values, wherein the binary encoded set of HRTF angle values includes binary encoded azimuth angle values and binary encoded elevation angle values;
input the set of binary encoded HRTF angle values to a neural network to generate a compressed representation of HRTF;
input the compressed representation of the HRTF to a HRTF reconstruction model to generate the HRTF; and
modify an audio signal based on the HRTF and send the modified audio signal to a first speaker.

14. The computer-readable medium of claim 13, wherein the binary encoded set of HRTF angle values further includes a sign bit indicative of locations of the corresponding binary encoded azimuth angle values and the binary encoded elevation angle values with respect to a median plane.

15. The computer-readable medium of claim 13, wherein the neural network comprises a fully connected feedforward network having two hidden layers and wherein at least one of the two hidden layers comprises a hyperbolic tangent activation function.
